(19) United States
(12) Patent Application Publication
(10) Pub. No.: US 2025/0329224 A1
(43) Pub. Date: Oct. 23, 2025

(54) GAME SYSTEM CAPABLE OF MAINTAINING GAMEPLAY CONTINUITY FOR PLAYER

(71) Applicant: JUMBO TECHNOLOGY CO., LTD., TAICHUNG CITY (TW)

(72) Inventors: Shun Tsung HSU, TAICHUNG CITY (TW); Chang Yi WANG, TAICHUNG CITY (TW); Lien Yung LIN, TAICHUNG CITY (TW)

(21) Appl. No.: 19/257,804

(22) Filed: Jul. 2, 2025

Related U.S. Application Data
(63) Continuation of application No. PCT/CN2023/082136, filed on Mar. 17, 2023.

(51) Int. Cl. G07F 17/32; G07F 17/34

(52) U.S. Cl. CPC G07F 17/3267; G07F 17/3211; G07F 17/3216; G07F 17/34

(57) ABSTRACT

The invention provides a game system capable of maintaining gameplay continuity for a player, including an operation element, a game processing element, and a display device. The game processing unit allows a player to operate to play the slot game and generate a primary game process, and produces a main real-time game image associated with the slot game based on the primary game process. When a reward game is triggered, the game processing unit initiates a sub-game process to generate a sub real-time game image associated with the reward game. The main and sub real-time game images are generated simultaneously. The display device includes a main display area displaying the main real-time game image and at least one sub display area displaying the sub real-time game image. This allows the main and sub real-time game images to be displayed simultaneously, ensuring that the primary game process continues without interruption.

### TECHNICAL FIELD

The present invention relates to a game system, in particular to a game system capable of maintaining gameplay continuity for a player.

### BACKGROUND

As shown in FIG. 1, a slot machine 1 is disclosed, which is a type of gaming machine that is highly popular among players. The slot machine 1 includes a plurality of reels 2. After the players placing a bet, the reels 2 are activated to spin, and scores are awarded based on symbol combinations formed when the reels stop.

Another common gameplay method for reward games, as illustrated in FIG. 4 of U.S. Pat. No. 8,197,328, involves allowing the reels to re-spin. Additionally, U.S. Pat. No. 10,629,030 B2 discloses a method in which the score of mystery symbols is determined based on collected configurable symbols.

However, the reward games and slot games are essentially two different types of games, and conventional gaming machines can only run one at a time. In other words, when a reward game is in progress, a slot game is paused or interrupted. As a result, there is a significant chance that the players may end the slot game after completing the reward game, leading to a break in the overall game flow. From the operator's perspective, the reward game is provided free of charge, and during the period when the slot game is interrupted to run the reward game, no additional revenue is generated from the gaming machine.

### BRIEF SUMMARY

A subject of the invention is to provide a game system capable of maintaining gameplay continuity for players by simultaneously displaying a main real-time game image and a sub real-time game image, thereby allowing a primary game to continue without interruption.

To achieve the above-mentioned object, the invention provides a game system capable of maintaining gameplay continuity for players, which provides a slot game that, upon meeting a specified condition, triggers a reward game. The game system includes an operation element, a game processing unit, and a display device.

The operation element allows a player to operate to play the slot game and generate a primary game process. Based on the primary game process, the game processing unit produces a main real-time game image associated with the slot game.

When the reward game is triggered, the game processing unit initiates a sub-game process to generate a sub real-time game image associated with the reward game. The main and sub real-time game images can be generated simultaneously.

The display device includes a main display area and at least one sub display area. The main display area displays the main real-time game image, while the at least one sub display area displays the sub real-time game image.

In summary, the present invention enables the display device to include a main display area and at least one sub display area. As a result, the main display area can display the main real-time game image, while the at least one sub display area can display the sub real-time game image. This allows both the main and sub real-time game images to be displayed simultaneously, thereby ensuring that the primary game process continues without interruption.

### BRIEF DESCRIPTION OF FIGURES

FIG. 1 is a schematic diagram of the appearance of the conventional slot machine.

FIG. 2 is a schematic diagram of a game machine of the present invention.

FIG. 3 is a block diagram of a system of the present invention.

FIG. 4 is a schematic diagram of a main real-time game image in the present invention.

FIG. 5 is a schematic diagram of a sub real-time game image in the present invention.

FIG. 6A-6B are schematic diagrams of the changes in accumulative quantity of a reward game displayed in the game machine of the present invention.

FIG. 7 is a schematic diagram of another game machine of the present invention.

FIG. 8 is a schematic diagram of a display screen of another game machine of the present invention.

FIG. 9A-9B are schematic diagrams of the display content on at least one sub display area in the present invention.

FIG. 10A-10C are schematic diagrams of the changes in display areas in the present invention.

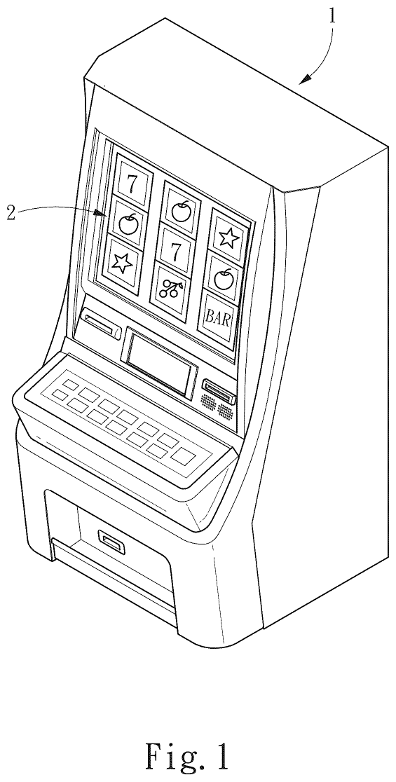

### DETAILED DESCRIPTION

The detailed description and technical content of the present invention are described now as follows in conjunction with the drawings.

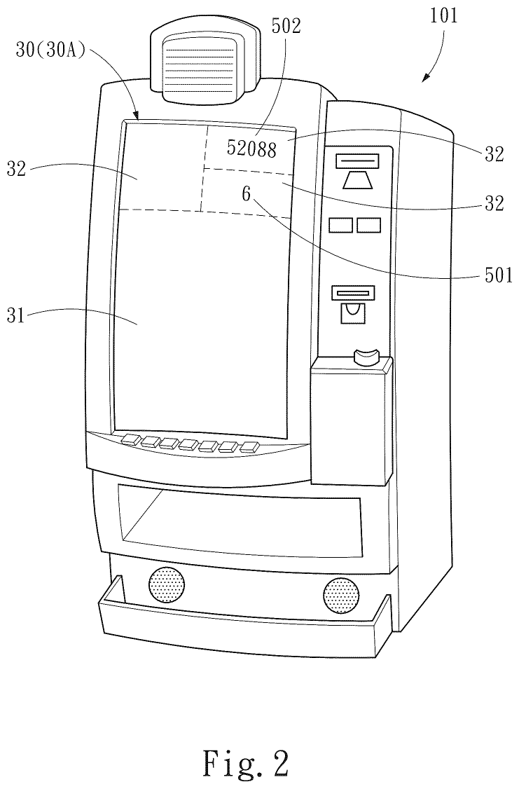

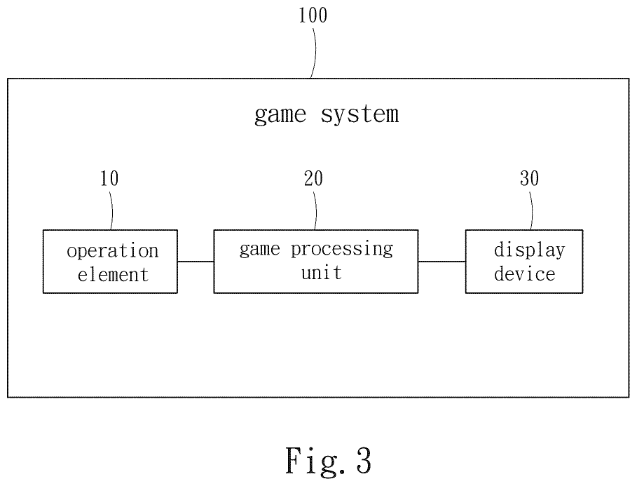

As shown in FIG. 2 and FIG. 3, the present invention provides a game system 100 capable of maintaining gameplay continuity for a player, which provides a slot game that, upon meeting a specified condition, triggers a reward game. The game system 100 is installed within a game machine 101 and comprises an operation element 10, a game processing unit 20, and a display device 30. The operation element 10 is provided for a player to play the slot game and generate a primary game process.

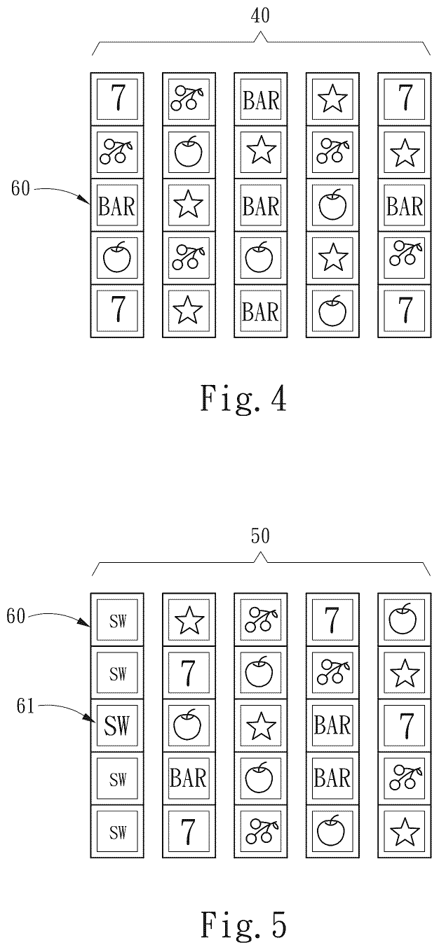

As shown in FIG. 4 and FIG. 5, the game processing unit 20 generates a main real-time game image 40 based on the primary game process, and the main real-time game image 40 is associated with the slot game.

In one example, as shown in FIG. 4, when at least five “BAR” symbols appear, the specified condition is met, triggering the reward game. After the reward game is triggered, the game processing unit 20 initiates a sub-game process to produce a sub real-time game image 50, which is associated with the reward game.

Both the main real-time game image 40 and the sub real-time game image 50 can be generated simultaneously. More specifically, the game processing unit 20 is capable of generating the main real-time game image 40 and the sub real-time game image 50 at the same time.

The main real-time game image 40 and the sub real-time game image 50 respectively correspond to game screens of the slot game and the reward game. The slot game and the reward game are independent games, and the player can earn scores from each game separately.

In one example, the slot game and the reward game may feature similar gameplay mechanics. For example, as shown in FIG. 4 and FIG. 5, both games utilize reels 60 arranged in the same number and configuration, and the score is determined based on the combination of symbols obtained after the reels 60 spin. The key difference is that in the reward game, the reels 60 can be activated without requiring any additional bets.

Furthermore, the symbols that appear on the reels 60 during the reward game may include special symbols 61 that do not appear in the standard slot game. The special symbols 61 can serve various functions depending on the game design. For instance, as shown in FIG. 5, a special symbol 61 can expand vertically to replace an original symbol and act as a universal symbol. This significantly increases the chances of achieving a high score.

In addition, in one example, the slot game and the reward game may feature different gameplay mechanics. For example, the reels 60 in the slot game and the reward game may differ in number, arrangement, and spinning behavior. Alternatively, the reward game may adopt a completely different gameplay style, such as a pachinko game or another format, rather than using reels. This variation is intended to provide the player with a fresh and engaging experience, helping to avoid fatigue and enhance overall enjoyment.

As shown in FIG. 2, FIG. 3, FIG. 4 and FIG. 5, the display device 30 includes a main display area 31 and at least one sub display area 32. The main display area 31 displays the main real-time game image 40, while the at least one sub display area 32 displays the sub real-time game image 50.

In one example, the display device 30 includes a display screen 30A, which is partitioned into separate areas serving as the main display area 31 and the at least one sub display area 32. As shown in FIG. 2, there are three sub display areas 32 in this example.

In one example, after the reward game is triggered, the game processing unit 20 immediately initiates the sub-game process to generate the sub real-time game image 50 without waiting for the player's input. Additionally, during the sub-game process, the display device 30 also displays a remaining number 501 of the reward game yet to be played.

Preferably, the remaining number 501 of the reward game yet to be played may be displayed in one of the three sub display areas 32 (as shown in FIG. 2). At the same time, the display device 30 may also display a score 502 of the sub real-time game image 50 during the sub-game process. Likewise, the score 502 of the sub real-time game image 50 can be shown in another sub display area 32.

In one example, when the number of the remaining number 501 of the reward game yet to be played is more than one, the game processing unit 20 may generate a corresponding number of sub real-time game images 50 simultaneously, based on the number of the sub display areas 32. Each of the sub real-time game images 50 simultaneously generated is displayed individually in each of the sub display areas 32.

For example, if the number of the remaining number 501 of the reward game yet to be played is six, and the number of the at least one sub display area 32 is three, the game processing unit 20 can generate three sub real-time game images 50 at the same time and display them across the three sub display areas 32. In this way, the remaining number 501 of the reward game yet to be played can be processed at a maximum speed, completing all of them in just two rounds.

In one example, the player can manually set the number of sub real-time game images 50 to be generated simultaneously by the game processing unit 20. For example, if the number of the remaining number 501 of the reward game yet to be played is six, and the number of the at least one sub display area 32 is three, the player may choose to set the game processing unit 20 to generate only two sub real-time game images 50 at a time. In such a case, the game processing unit 20 will generate only two sub real-time game images 50 simultaneously and display them across any two of the sub display areas 32. This customization allows the gameplay experience to better align with the player's personal preferences.

In one example, if the reward game includes different types of gameplay, the sub real-time game images 50 corresponding to different types of reward games may also be displayed in different sub display areas 32. In other words, the sub real-time game image 50 of the reward game with a specific gameplay style is in a specific sub display area 32.

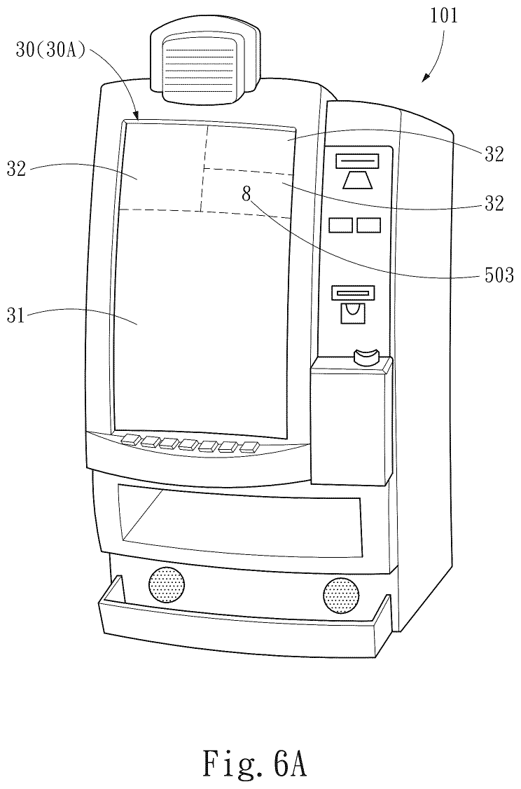

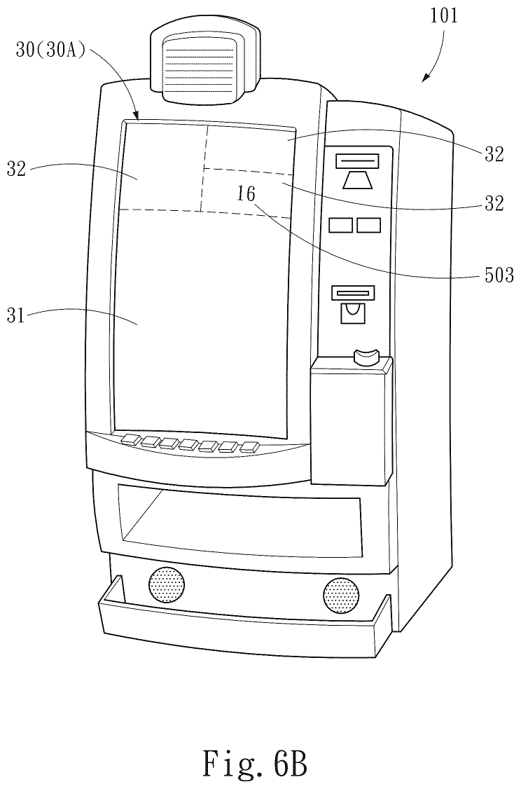

As shown in FIG. 3, FIG. 6A and FIG. 6B, in one example, after the reward game is triggered, the game processing unit 20 may temporarily delay proceeding in the sub-game process and record an accumulated number 503 of the reward game. The sub-game process will begin only after the player operates and selects through the operation element 10. The display device 30 displays the accumulated number 503 of the reward game. Preferably, the accumulated number 503 of the reward game is displayed in any one of the sub display areas 32.

As shown in FIG. 6A, the accumulated number 503 of the reward game has reached a total of eight. When the slot game once again meets the specified condition and triggers additional reward games-adding eight more reward games—the accumulated number 503 increases to a total of sixteen, as illustrated in FIG. 6B.

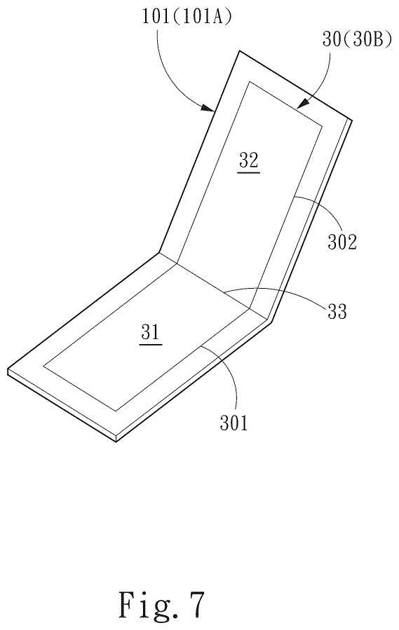

Please also refer to FIG. 7. In one example, the game machine 101 may be implemented using a foldable mobile device 101A. A display screen 30B of the display device 30 may be a foldable screen, which is partitioned along a folding line 33 into a first area 301 and a second area 302. The main display area 31 is located in the first area 301, while the at least one sub display area 32 is located in the second area 302.

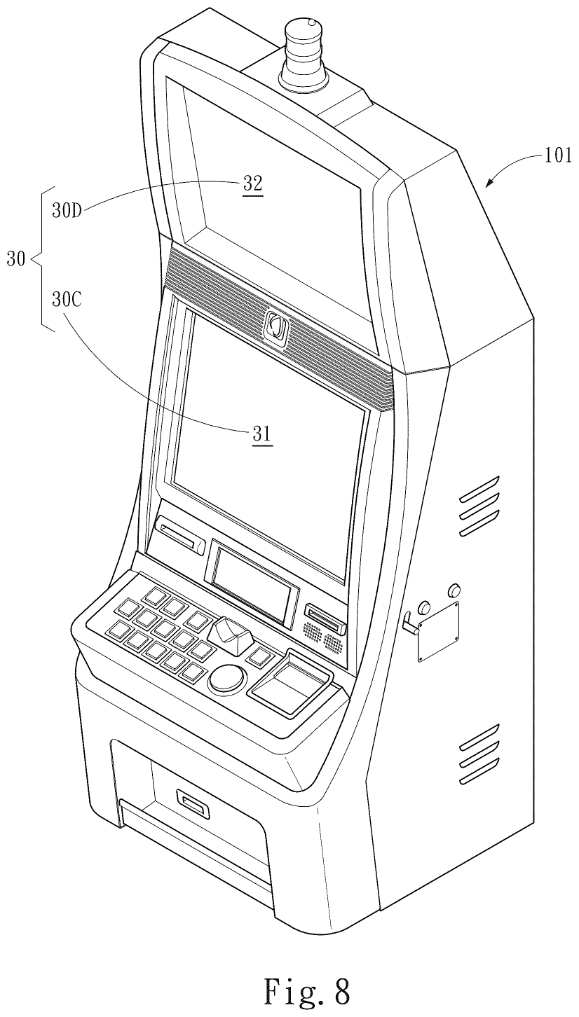

Please also refer to FIG. 8. In one example, the display device 30 includes two display screens 30C and 30D, which serve respectively as the main display area 31 and the at least one sub display area 32. These two display screens 30C and 30D can be flexibly assigned based on user requirements—meaning that screen 30D may also function as the main display area 31, while screen 30C serves as the at least one sub display area 32 (this configuration is not illustrated). The two display screens 30C and 30D may be arranged vertically on the game machine 101, as shown in FIG. 8. Alternatively, the two display screens 30C and 30D may be arranged side-by-side horizontally on the game machine 101 (this configuration is not illustrated).

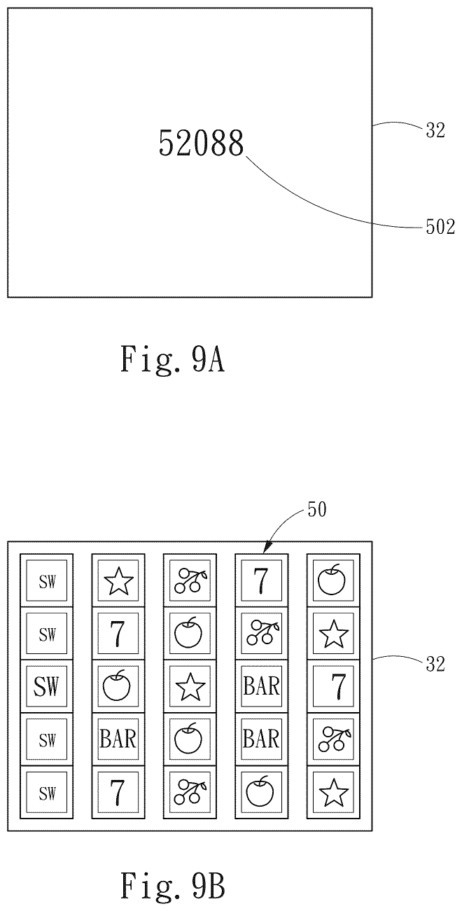

As shown in FIG. 3, FIG. 9A and FIG. 9B, in one example, the at least one sub display area 32 initially displays only the score 502 corresponding to the sub real-time game image 50 (as shown in FIG. 9A). The sub real-time game image 50 displays only after the player operates and selects through the operation element 10 (as shown in FIG. 9B).

More specifically, the at least one sub display area 32 initially shows only the score of the reward game (which corresponds to the sub real-time game image 50). Once the player chooses to view the sub real-time game image 50 by operating and selecting via the operation element 10, the at least one sub display area 32 then switches to display a corresponding sub real-time game image 50.

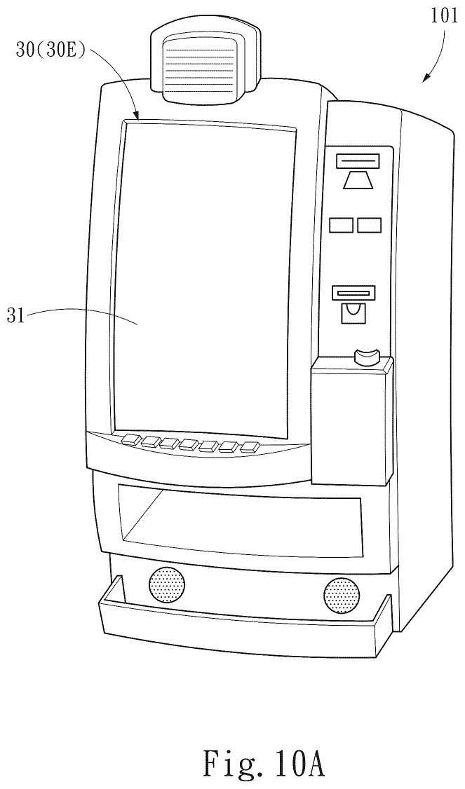

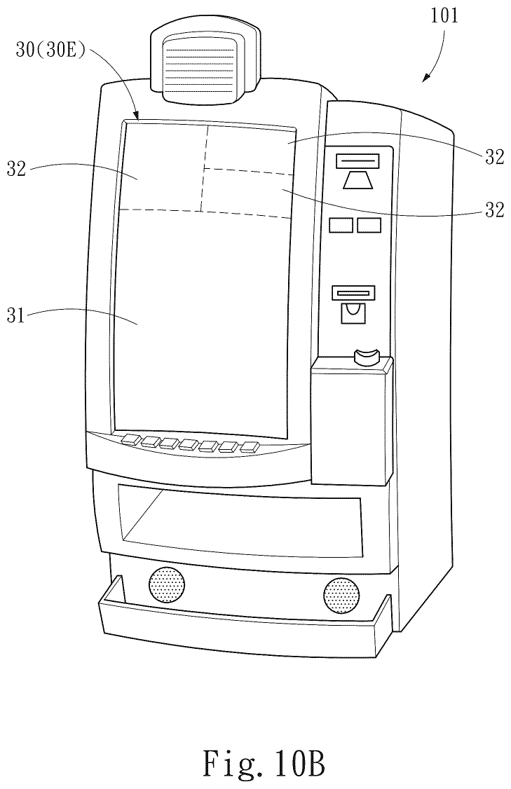

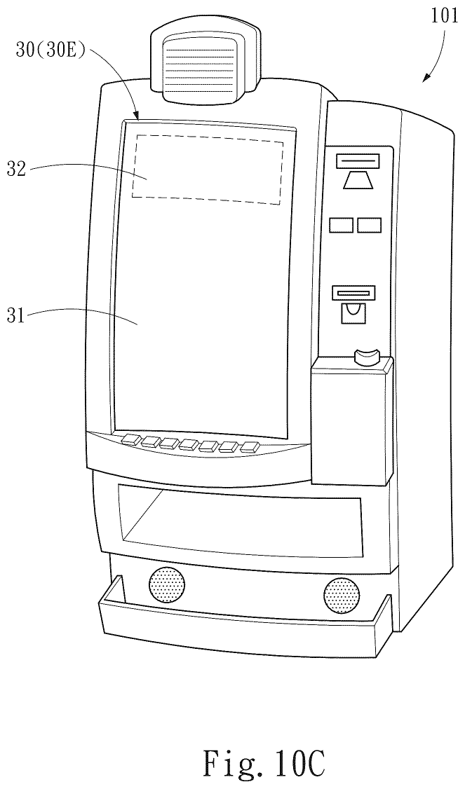

As shown in FIG. 10A, FIG. 10B and FIG. 10C, in one example, the display device 30 includes a display screen 30E, where an entire display area initially serves as the main display area 31 (as shown in FIG. 10A). When needed, at least one sub display area 32 is formed by partitioning a portion of the main display area 31 (as shown in FIG. 10B). Alternatively, the at least one sub display area 32 may also be overlaid directly on top of the main display area 31 when needed (as shown in FIG. 10C).

In summary, the present invention has at least the following advantages:

By configuring the display device with a main display area and at least one sub display area, the main real-time game image and the sub real-time game image can be displayed simultaneously. This ensures that the primary game process continues uninterrupted, thereby effectively increasing an operational revenue of the game system.

The players are allowed to accumulate reward games and choose the timing of when to play them, which helps avoid disrupting a flow of the primary game process.

A plurality of sub display areas can simultaneously display a plurality of sub real-time game images that are generated at the same time, enabling faster completion of a plurality of reward games.

What is claimed is:

1. A game system capable of maintaining gameplay continuity for a player, providing a slot game that, upon meeting a specified condition, triggers a reward game, and the game system comprising:
an operation element, provided for a player to operate to play the slot game and generate a primary game process;
a game processing unit, producing a main real-time game image associated with the slot game based on the primary game process, and when the reward game is triggered, the game processing unit initiating a sub-game process to generate a sub real-time game image associated with the reward game, and the main and sub real-time game images being generated simultaneously; and
a display device, comprising a main display area configured to display the main real-time game image, and at least one sub display area configured to display the sub real-time game image.

2. The game system of claim 1, wherein the game processing unit initiates a sub-game process after the reward game is triggered.

3. The game system of claim 2, wherein the display device displays a remaining number of the reward game yet to be played during the sub-game process.

4. The game system of claim 2, wherein the display device displays a score of the sub real-time game image during the sub-game process.

5. The game system of claim 1, wherein the game processing unit temporarily delays proceeding in the sub-game process and records an accumulated number of the reward game, after the reward game is triggered, and the sub-game process will begin only after the player operates and selects through the operation element.

6. The game system of claim 5, wherein the display device displays the accumulated number of the reward game.

7. The game system of claim 6, wherein the accumulated number of the reward game is displayed in any one of sub display areas.

8. The game system of claim 1, wherein the display device comprises one sub display area display, and the sub display area displays a score corresponding to the sub real-time game image, and the at least one sub display area is controlled to display the sub real-time game image only after the player operates and selects through the operation element.

9. The game system of claim 1, wherein the display device includes two display screens serving respectively as the main display area and the at least one sub display area.

10. The game system of claim 9, wherein the two display screens are interchangeably used as the main display area and the sub display area.

11. The game system of claim 9, wherein the two display screens are arranged vertically on a game machine.

12. The game system of claim 9, wherein the two display screens are arranged side-by-side horizontally on a game machine.

13. The game system of claim 1, wherein the display device includes a display screen, which is partitioned into two areas and serves respectively as the main display area and the at least one sub display area.

14. The game system of claim 13, wherein the display screen is a foldable screen partitioned along a folding line into a first area and a second area, and the main display area is located in the first area, while the at least one sub display area is located in the second area.

15. The game system of claim 1, wherein when a remaining number of the reward game yet to be played is more than one, the game processing unit generates a corresponding number of sub real-time game images simultaneously, based on a number of the at least one sub display area, and each of the sub real-time game images simultaneously generated is displayed individually in each sub display area.

16. The game system of claim 15, wherein if the reward game comprises different types of gameplay, the sub real-time game images corresponding to different types of reward games are displayed in different sub display areas.

17. The game system of claim 1, wherein the display device includes a display screen, where an entire display region of the display screen serves as the main display area, and the at least one sub display area is formed by partitioning a portion of the main display area when needed.

18. The game system of claim 1, wherein the display device includes a display screen, where an entire display region of the display screen serves as the main display area, and the at least one sub display area is overlaid directly on top of the main display area when needed.
